(19) United States
(12) Patent Application Publication
(10) Pub. No.: US 2014/0097274 A1
(43) Pub. Date: Apr. 10, 2014

(54) Rapid Mechanically-Connected Sprinkler System

(71) Applicant: Elkhart Products Corporation, c/o Aalberts Industries N.V., Langbroek (NL)

(72) Inventor: Robert J. Smyrl, Bryn Mawr, PA (US)

(73) Assignee: Elkhart Products Corporation, c/o Aalberts Industries N.V., Langbroek (NL)

(21) Appl. No.: 14/103,650

(22) Filed: Dec. 11, 2013

Related U.S. Application Data
(63) Continuation of application No. 13/207,297, filed on Aug. 10, 2011.
(60) Provisional application No. 61/372,722, filed on Aug. 11, 2010.

(51) Int. Cl. B05B 15/06

(52) U.S. Cl. CPC B05B 15/069
USPC 239/550; 239/600; 29/428

(57) ABSTRACT

The present disclosure is directed to a sprinkler assembly that includes a sprinkler head and a fitting. The fitting has a recess in a distal end for receiving a pipe end. The fitting also has a sealing ring in the recess to provide a fluid-tight seal between the sprinkler head and the pipe end upon installation of the pipe. In one embodiment, the pipe is installed by pushing the pipe end into the fitting (i.e., pushing actuates the fitting). In another embodiment, the pipe is installed by inserting the pipe end into the fitting and using a tool to press-actuate the fitting. During installation, a sharp-edged grip-ring or grab-ring in the recess of the fitting, which in some embodiments has a plurality of teeth, engages the outer surface of the pipe end, holding the pipe securely in place.

### CROSS-REFERENCE TO RELATED APPLICATIONS

This application is a division of U.S. patent application Ser. No. 13/207,297, filed Aug. 10, 2011 and entitled, “RAPID MECHANICALLY-CONNECTED SPRINKLER SYSTEM.” This application also claims priority to U.S. Provisional Application No. 61/372,722, filed Aug. 11, 2010 and entitled, “PUSH-CONNECT SPRINKLER SYSTEM.” In addition, this application is related to U.S. patent application Ser. No. 12/818,942, filed Jun. 18, 2010 and entitled “PRESS-CONNECT FITTING WITH IMPROVED GRAB-RING FUNCTION,” the disclosures of which are incorporated herein by reference in their entirety.

### TECHNICAL FIELD

The concepts described herein generally relate to sprinkler systems. More specifically, the described concepts relate to sprinkler systems in which sprinkler heads are installed using rapid mechanical connections, including press-connect and push-connect fittings.

### BACKGROUND

Fire sprinkler systems are most commonly installed in commercial buildings and are relied upon to eliminate or at least thwart the spread of fire before an emergency response team arrives. During sprinkler system installation, a grid of piping, typically polyvinyl chloride (PVC), steel, or copper piping, is erected throughout the entirety of the building and arranged in a network-type orientation. The piping is often supported by extension rods that extend from the ceiling to a predetermined height above the floor. At selected intervals along these pipes are independent, heat activated valves known as sprinkler heads, which are responsible for water distribution onto the fire. The sprinkler heads are installed along the piping by fixing them at apertures in the piping at spaced intervals.

Although fire sprinkler systems may be installed by mechanically-minded individuals, the job is usually reserved for professionals, as it can be very tedious to install and align the sprinkler heads. Installers of the sprinkler heads, including professionals, typically must either actuate a threaded portion of the sprinkler head within a threaded aperture within the piping or must weld or solder the sprinkler head to the piping. Each method requires additional tools and is labor and cost intensive.

### BRIEF SUMMARY

Disclosed herein is a sprinkler assembly that comprises a sprinkler head and a fitting, and a method for installing same. The fitting has a recess in a distal end for receiving a pipe end. The fitting also has a sealing ring in the recess to provide a fluid-tight seal between the sprinkler head and the pipe end upon installation of the pipe. In one embodiment, the pipe is installed by pushing the pipe end into the fitting (i.e., pushing actuates the fitting). In another embodiment, the pipe is installed by inserting the pipe end into the fitting and using a tool to press-actuate the fitting. During installation, a sharp-edged grip-ring or grab-ring in the recess of the fitting, which in some embodiments has a plurality of teeth, engages the outer surface of the pipe end, holding the pipe securely in place.

The foregoing has outlined rather broadly the features and technical advantages of the various embodiments in order that the detailed description that follows may be better understood. Additional features and advantages will be described hereinafter which form the subject of the claims. It should be appreciated by those skilled in the art that the conception and specific embodiment disclosed may be readily utilized as a basis for modifying or designing other structures for carrying out the same purposes. It should also be realized by those skilled in the art that such equivalent constructions do not depart from the spirit and scope of the embodiments as set forth in the appended claims. The novel features which are believed to be characteristic of the embodiments, both as to its organization and method of operation, together with further objects and advantages will be better understood from the following description when considered in connection with the accompanying figures. It is to be expressly understood, however, that each of the figures is provided for the purpose of illustration and description only.

### BRIEF DESCRIPTION OF THE DRAWINGS

For a more complete understanding of the embodiments described herein, reference is now made to the following descriptions taken in conjunction with the accompanying drawing, in which:

FIGS. 1A-1B depict a side view of prior art sprinkler heads;

FIG. 2A depicts a side view of a push-connect sprinkler assembly according to an embodiment;

FIG. 2B depicts a cross-sectional view of a push-connect sprinkler assembly according to an embodiment;

FIG. 2C depicts a side-view of a push-connect sprinkler assembly being joined with a sprinkler system pipe according to an embodiment;

FIG. 2D depicts a cross-sectional view of a sprinkler system pipe secured by an actuated push-connect fitting;

FIG. 3A depicts a side view of a push-connect sprinkler assembly according to an embodiment;

FIG. 3B depicts a cross-sectional view of a push-connect sprinkler assembly according to an embodiment;

FIG. 3C depicts a side-view of a push-connect sprinkler assembly being joined with a sprinkler system pipe according to an embodiment;

FIGS. 4A and 4B depict perspective views of a push-connect fitting having multiple receiving areas according to an embodiment;

FIG. 5 depicts a push-connect fitting have a threaded portion according to an embodiment;

FIGS. 6A and 6B depict T-joint push-connect fittings according to an embodiment;

FIG. 6C depicts a sprinkler assembly having a T-joint push-connect fitting according to an embodiment;

FIG. 7 depicts an elbow push-connect fitting according to an embodiment;

FIG. 8A depicts a cross-sectional view of a press-connect sprinkler assembly in a neutral position according to an embodiment; and

FIG. 8B depicts a cross-sectional view of a press-connect sprinkler assembly in an engaged position according to an embodiment.

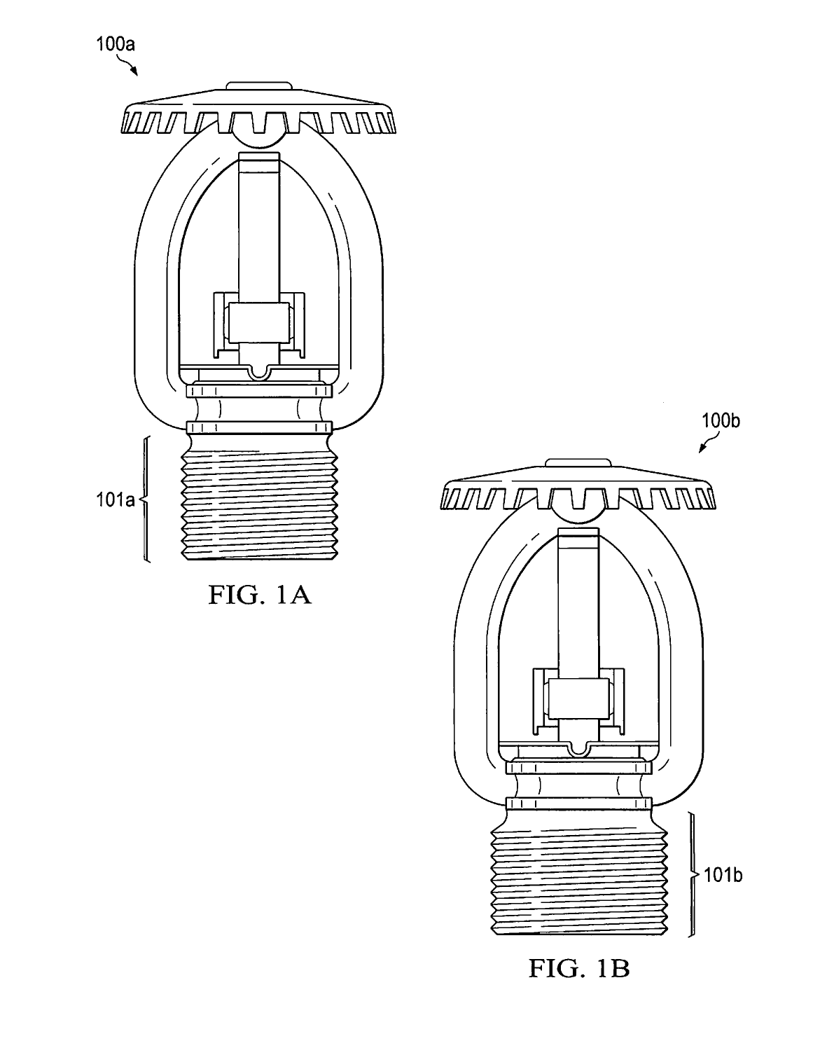

### DETAILED DESCRIPTION

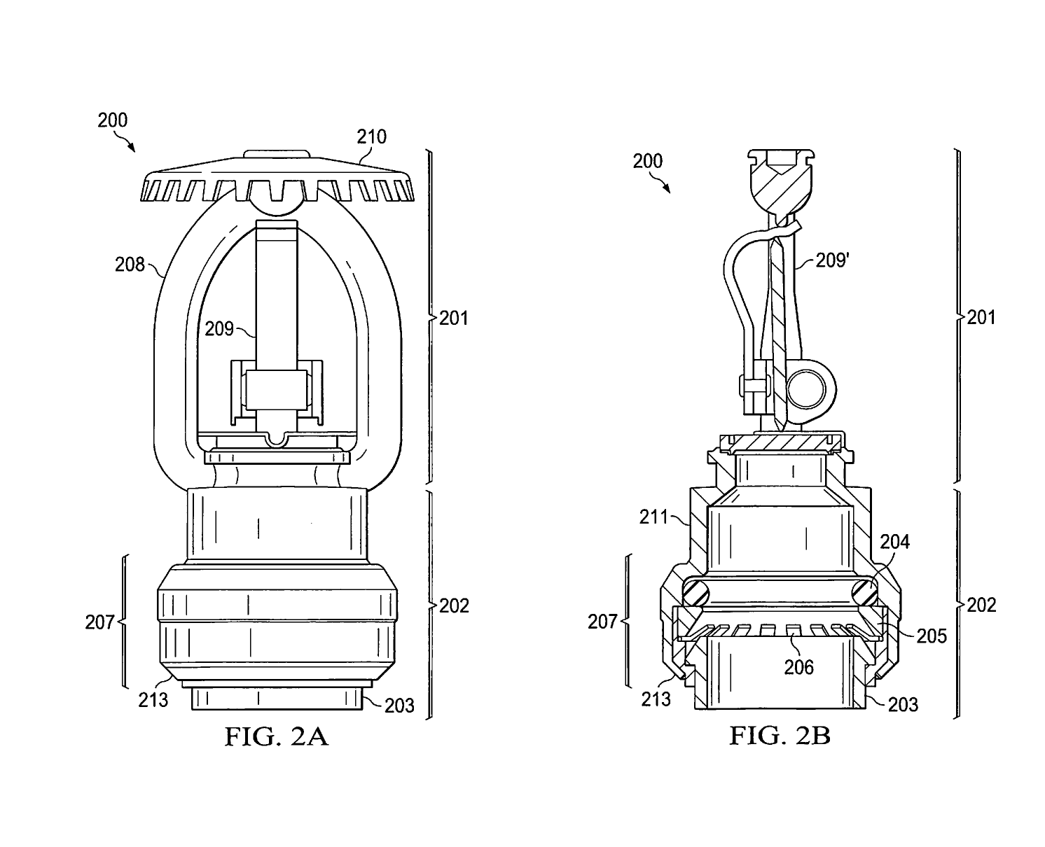

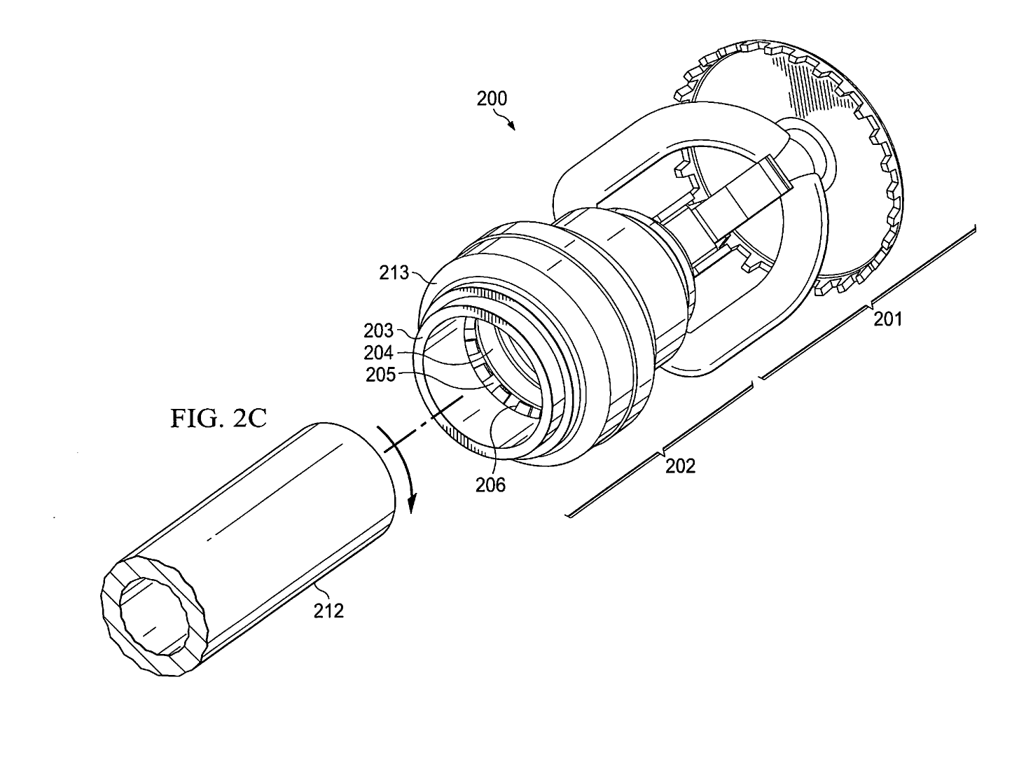

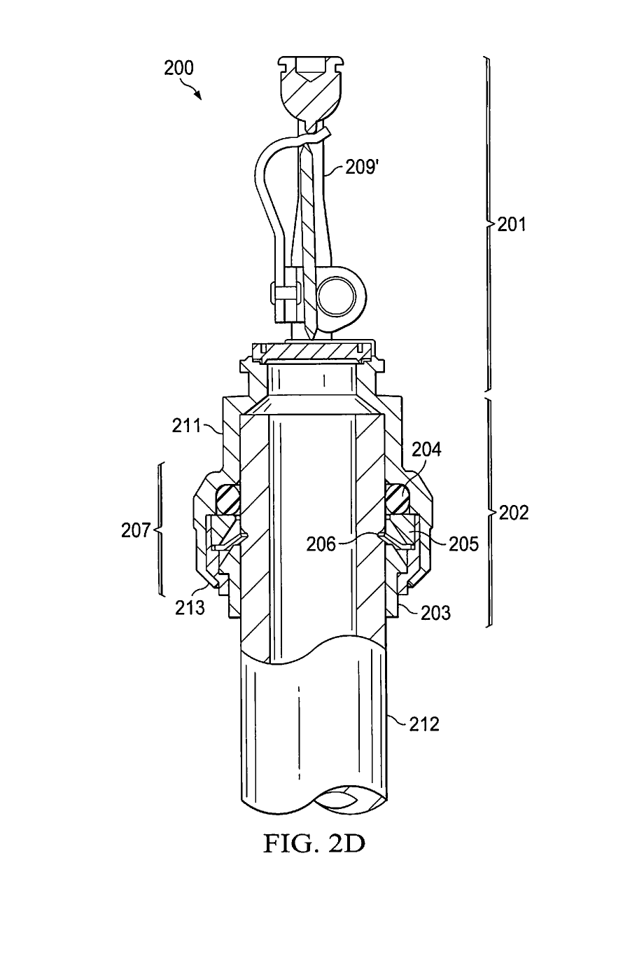

The concepts described herein, and shown in FIGS. 2A through 8B, involve a sprinkler head installed on a sprinkler system pipe using press-connect and push-connect fittings where the fitting is used to join the sprinkler head to the sprinkler system pipe.

A push-connect fitting, which is particularly useful in plumbing applications, is a system that can be used to rapidly join sprinkler system pipes, tubes, or other components for managing fluid flow in a manner that creates a fluid-tight seal with only minimal and simple tools (no tool for pressing), and without additional heat (e.g., torch) or sealants (e.g., glue, flux, solder, and other consumables). Thus, a push-connect fitting is a “clean” way to assemble sprinkler (or other flow management system) components. A push-connect fitting will form a durable, yet reversible joint between the push-connect fitting and sprinkler system pipe.

In a system including a push-connect fitting, a seal between the push-connect fitting and sprinkler system pipe is created simply by inserting the sprinkler system pipe into the press-connect fitting. Embodiments of the push-connect sprinkler assembly disclosed herein include a sprinkler head (for dispensing water received from sprinkler system pipe), and a push-connect fitting. The push-connect fitting connects the sprinkler head to a sprinkler system pipe (water supply line) and includes an O-ring (sealing-ring), a grip-ring, a protective ring (spacer-ring), and in some embodiments, a guide-ring. The O-ring, grip-ring, protective-ring, and guide ring are elements that can be housed (in whole or in part) in a receiving area (recess) formed in the end of the push-connect fitting. The O-ring, located closest to the sprinkler head, can be used to create a water tight seal between the push-connect fitting and sprinkler system pipe. The protective ring, located between the O-ring and grip-ring, can be used to separate and protect the O-ring from the grip-ring during the push-connect operation (i.e., when the push-connect sprinkler is being joined to sprinkler system pipe). The grip-ring secures sprinkler system pipe such that the sprinkler head and sprinkler system pipe will remained joined until intentionally disconnected. To perform this function, the grip-ring includes several internal sharp-edged teeth that penetrate the outer surface of the sprinkler system pipe. The guide ring may help guide the sprinkler system pipe into proper alignment with the push-connect fitting, and may also serve to aid in separation of the push-connect fitting and sprinkler system pipe. An end cap, which is an area of the outer covering of the push connect fitting close to the receiving end (where pipe is first received/inserted), may further help guide the sprinkler system pipe into proper alignment with the push-connect fitting.

Because heat or additional sealants are not used, a push-connect fitting presents the further advantage of allowing two push-connected components to be disconnected (detached) without damage to the fitting, such that the fitting may be reused, if desired. The guide-ring may help in this regard. Disconnection may require use of a specialized tool.

A press-connect fitting, which is also particularly useful in plumbing applications, is a system that can be used to rapidly join sprinkler system pipes, tubes, or other components for managing fluid flow in a manner that creates a fluid-tight seal where only minimal tools (the tool for pressing), and no additional heat (e.g., torch) or sealant (e.g., glue, flux, solder, and other consumables) is needed. Thus, a press-connect fitting is a “clean” way to assemble sprinkler (or other flow management system) components. Using a press-connect fitting will form a permanent durable joint between the sprinkler assembly and sprinkler system pipe.

In a system including a press-connect fitting, a seal between the press-connect fitting and sprinkler system pipe is created by inserting the sprinkler system pipe into the press-connect fitting, and using a separate tool, pressing a receiving area of a press-connect sprinkler assembly to form a leak proof and structurally capable joint for managing fluid flow. Embodiments of a press-connect sprinkler assembly disclosed herein include a sprinkler head and a press-connect fitting. The press-connect fitting includes an O-ring (sealing-ring), a grab-ring (press-ring), and a spacer-ring (protective-ring). The O-ring, grab-ring, and spacer-ring are elements that can be recessed into a receiving area formed in the end of the press-connect fitting. The O-ring, located closest to the sprinkler head, can be used to create a water tight seal between the press-connect fitting and sprinkler system pipe. The spacer-ring, located between the O-ring and grab-ring, can be used to separate and protect the O-ring from the grab-ring during the press-connect operation (i.e., when the pipe is inserted and the fitting is being pressed). When the press-connect fitting is pressed, the grab-ring's diameter is reduced, forcing a sharp edge (in some embodiments, a plurality of teeth) lining its circumference to become embedded in the outer surface of the sprinkler system pipe.

Both press-connect and push-connect fittings allow various materials to be joined, even dissimilar materials. Thus, sprinkler systems using press-connect and push-connect fittings are more flexible than systems known in the art, as well as easier and more efficient, to install, repair, and retrofit. In a preferred embodiment, the sprinkler head, push-connect or press-connect fitting, and sprinkler system pipe are copper or brass, which are common plumbing materials. Depending on the specific application, sprinkler head, push-connect fitting, and for sprinkler system pipe may be other materials, such as steel, chlorinated polyvinyl chloride (CPVC), and cross-linked polyethylene (PEX), or a combination of such materials. For example, a brass sprinkler head may be joined with a CPVC water supply line via a push-connect fitting. In one embodiment, such assembly may be further joined with a copper pipe via a second push-connect fitting.

FIGS. 2A, 2B, 2C, and 2D depict various perspectives of an embodiment of a push-connect sprinkler assembly according to embodiments described herein.

FIG. 2A depicts a side view of sprinkler assembly 200 and FIG. 2B depicts a cross-sectional view of sprinkler assembly 200. As shown in FIGS. 2A and 2B, push-connect sprinkler assembly 200 includes sprinkler head 201 (including sprinkler head frame 208, thermal actuator 209, 209′, and deflector 210) and push-connect fitting 202. Sprinkler head 201 can be a number of different types of sprinkler heads as are well known in the art. Although the embodiment shown in sprinkler assembly 200 includes sprinkler head 201, which is of a style typically used in fire extinguishing, the concepts discussed herein are not so limited and may include sprinklers or like mechanisms for any type of water or other fluid flow management. For example, sprinkler head 201 could also be a sprinkler for watering grass, another pipe, a hand-held manually actuated sprayer, sprinklers used for misting water, or a water faucet.

According to one aspect, sprinkler head 201 is specially adapted to connect to push-connect fitting 202. In one embodiment, push-connect fitting 202 may be integrally formed with portions of sprinkler head 201 by casting. After cast-forming certain portions (for example, sprinkler head frame 208, deflector 210, and push-connect casing 211), remaining components (e.g., O-ring, grip-ring, and protective-ring) may be added in the recess at the distal end of the push-connect sprinkler assembly. Further, push-connect fitting 202 has a proximal portion for connecting to sprinkler head 201, a distal portion for receiving sprinkler system pipe 212 (pipe shown in FIG. 2C).

According to an aspect, the receiving or distal end of push-connect fitting 202 that receives sprinkler system pipe has additional components, including guide-ring 203 (or guide-pipe), which is at least partially housed within the recess of push-connect fitting 202 and extends in a longitudinal direction from the base of receiving area 207. Guide-ring 203 helps guide sprinkler system pipe 212 or other tube into push-connect fitting 202. In this manner, guide-ring 203 helps ensure that sprinkler system pipe 212 is inserted in proper alignment, i.e., straight in this embodiment. In other embodiments, an angular insertion may be required such that the longitudinal length of sprinkler system pipe is at an angle with respect to sprinkler head 201. In such case, guide-ring 203 and other components housed in the recess would be angled to appropriately receive sprinkler system pipe 212. Further, push-connect fitting 202 may include end-cap 213 that further assists in ensuring proper insertion of sprinkler system pipe 212.

In one embodiment, guide-ring 203 further assists in allowing sprinkler assembly pipe 212 to be removed from push-connect fitting 202. This is advantageous because it provides for relatively fast decoupling of sprinkler head 201 from sprinkler system pipe 203, should the need for repairs, maintenance, and the like call for same. It also allows a sprinkler head to be reused.

FIG. 2C depicts a side-view of sprinkler assembly 200 being joined with sprinkler system pipe 212. Some push-connect fitting components may sit within a recess or flange area of push-connect fitting 202, and further within an area generally designated as receiving area 207. In the embodiment shown, receiving area 207 is a portion of push connect fitting 207 having an enlarged circumference relative to the proximal end of push-connect fitting 202 and is shaped so as to house O-ring 204, protective-ring 205, grip-ring 206, and a portion of guide-ring 203. As will be apparent to those skilled in the art, the specific shape of receiving area 207 and any recesses, grooves, or other guides within for holding such components may vary according to specific applications. For example, the diameter of receiving area 207 for inserting sprinkler system pipe 212 may be of a size sufficient to accommodate standard pipe or tube diameters, e.g., 1 inch, ½ inch, ¾ inch, or a custom size pipe or sprinkler component.

In the embodiment shown, O-ring 204 rests within a recess in receiving area 207 and contacts (or, alternatively, comes in close proximity to) a top surface of protective-ring 205. O-ring 204, according to the embodiment shown, forms a loop to circumscribe sprinkler system pipe 212 (when inserted) and has a circular-shaped cross-section (when in a relaxed state and not deformed). Further, O-ring 204 is in one embodiment an elastomer capable of being pressed or deformed to fill space and come into intimate contact with the inner surface of push-connect fitting 202 and outer surface of sprinkler system pipe 212. O-ring 204 is hydrophobic or otherwise impenetrable by the type of fluid handled in the system. O-ring 104 can also beneficially have a variety of cross sections, e.g., elliptical, circular, x-shaped, multi-lobal, square, etc., and could be further aligned or partially-seated in a groove or recess area of sprinkler system pipe 212 once inserted.

Protective-ring 205 is located between O-ring 204 and grip-ring 206 within receiving area 207 of push-connect fitting 202. Protective-ring 205 separates O-ring 204 and grip-ring 206 to circumscribe sprinkler system pipe 212 (when inserted). In one embodiment, protective-ring 205 substantially fills the space between O-ring 204 and grip-ring 206. Protective-ring 205 prevents O-ring 204 from getting damage or abrasions (e.g., from the edge of sprinkler system pipe 212 or from the sharp edges of grip-ring 206) during the installation operation (i.e., pushing or twisting sprinkler system pipe 212 into push-connect fitting 202). To offer such protection, protective-ring 205, in some embodiments, is a sufficiently hard material, e.g., plastic or the like. In some embodiments, protective-ring 205 may have elastomeric properties. Protective-ring 205 may also serve as support or stability for grip-ring 206. To perform such functions (space, protect, support), protective-ring 205 may have a variety of cross-sectionals shapes, depending on the application and shape of push-connect fitting 202. Potential shapes include triangular (as shown in FIG. 2B), circular, x-shaped, square, etc. A triangular shape may be particularly useful in that it allows teeth of grip-ring 206 to be oriented in a slightly upward position (toward sprinkler head 201), but preventing it from being completely parallel with sprinkler system pipe 212. Thus, when sprinkler system pipe 212 is inserted, the sharp-edged teeth of grip-ring 206 will still protrude sufficient to contact and penetrate the surface of sprinkler system pipe 212. Further, protective-ring 205 may be partially-seated within a groove of receiving area 207 and could further be aligned and/or seated within a groove in sprinkler system pipe 212 once installed.

Grip-ring 206 holds sprinkler system pipe 212 securely in place once installed (i.e., pushed in). Grip-ring 206 is located between protective-ring 205 and guide-ring 203 of receiving area 207 and circumscribes sprinkler system pipe 212 (when inserted). Further, in the embodiment shown, grip-ring 206 is comprised of a plurality of uniformly shaped and spaced teeth that traverse the circumference of push-connect fitting 202, and that extend outward from the inner surface of push-connect fitting 202. In one embodiment, these teeth are angled upward (toward sprinkler head 209, 209′) and/or in the direction sprinkler system pipe 212 is pushed during installation. Such angle may be between 85 degrees and 5 degrees (between 25 degrees and 5 degrees in some embodiments) from a plane orthogonal to the surface of the sprinkler system pipe 212. In another embodiment, teeth of grip-ring 206 may be orthogonal to the direction of such pushing. Although shown of uniform shape and equally spaced apart, such uniformity is not required. Such teeth may be of a variety of shapes and dimensions (uniform or not), and also tapered to a sharp point, if desired. In alternate embodiments, grip-ring 206 may be a continuous ring of material of various shapes, dimensions, and tapers. Material for grip-ring 206 should be of sufficient hardness and/or sharpness to penetrate the outer surface of an inserted sprinkler system pipe 212. The shape of grip-ring 206 should also be conducive to such gripping and penetrating action. The selected shape may depend on the type, hardness, and thickness of sprinkler system pipe being used. In some embodiments, a portion of grip-ring 206 may be located under protective-ring 205, behind and/or on top of guide-ring 203, and/or may rest or be secured within a recess of receiving area 207.

FIG. 2D shows an installed sprinkler system pipe 212. To install sprinkler system pipe 212 on sprinkler assembly 200 via push-connect fitting 202, sprinkler system pipe 212 is inserted into receiving area 207. This insertion exerts a mechanical stress on O-ring 204 causing deformation of O-ring 204. Such deformation results in close contact between O-ring 204 and the inner surface of push-connect fitting 202, as well as between O-ring 204 and the outer surface of sprinkler system pipe 212. That is, O-ring 204 substantially fills the space defined by the inner surface of push-connect fitting 202, the outer surface of sprinkler system pipe 212, and a recess or grove area in sprinkler system pipe 212, if any. A seal is thus formed that allows water or other fluid to flow from sprinkler system pipe 212 through push-connect fitting 202 and out of a sprinkler head 201 as intended (i.e., without leaking). So long as fluid introduced to the joined components does not exceed such mechanical stress, leaking will not occur. After inserting sprinkler system pipe 212, it is turned slightly. This rotation helps embed the sharp teeth of grip-ring 206 into the outer surface of sprinkler system pipe 212, but without penetrating the full depth of the wall of sprinkler system pipe 212.

It should be appreciated that during the installation process, push-connect fitting 202 could be first secured to sprinkler system pipe 212. In that case, sprinkler head 201 would be inserted into push-connect fitting 202, which would have been previously secured to sprinkler system pipe 212. In this way, pipe ends could be prepared with push-connect fittings and sprinkler heads could thereafter be installed simply by coupling sprinkler head, such as sprinkler head 201, with the push-connect fitting, such as push-connect fitting 202.

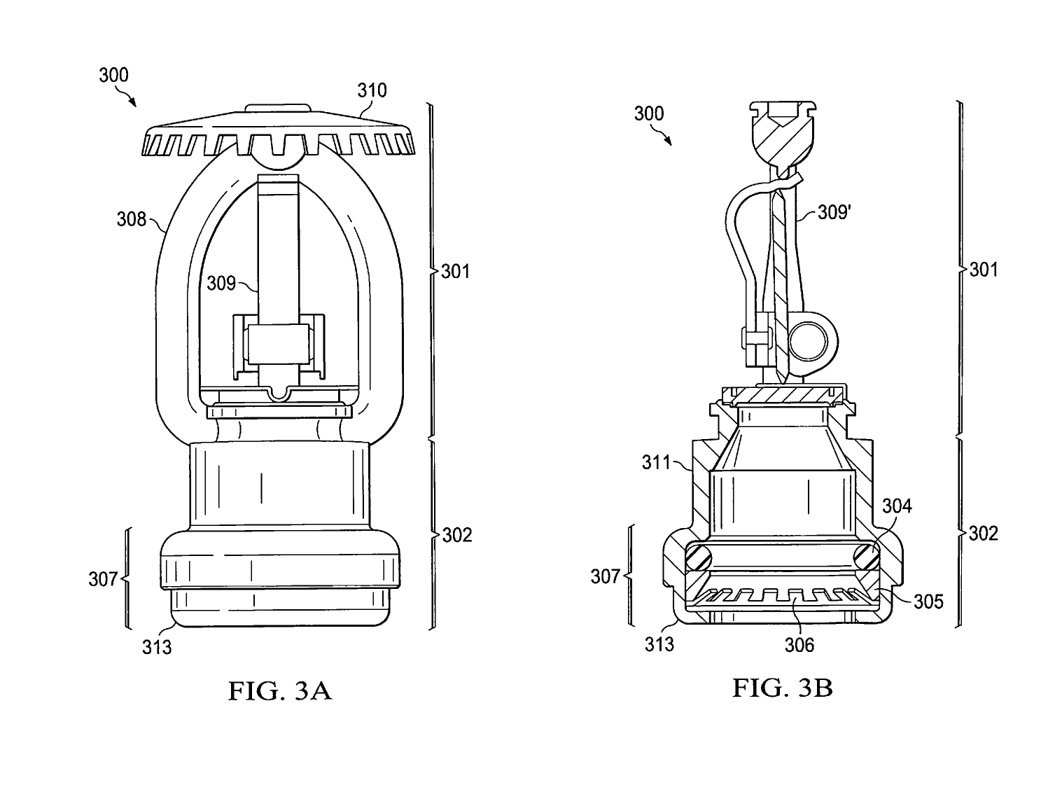

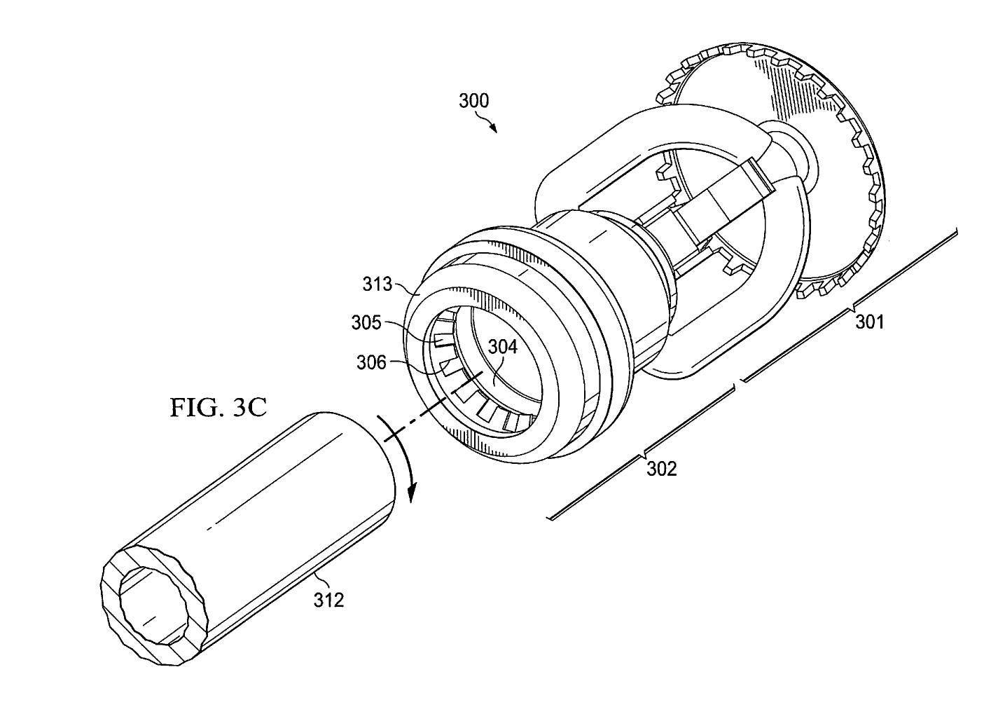

FIGS. 3A, 3B, and 3C show another embodiment of the push-connect sprinkler assembly. There is shown a push-connect sprinkler assembly 300 that includes sprinkler head 301 (including sprinkler head frame 308, thermal actuator 309, 309′, and deflector 310) and push-connect fitting 302. Push-connect fitting 302 has a proximal portion for connecting to sprinkler head 301, and a distal portion for receiving sprinkler system pipe 312 (pipe shown in FIG. 3C). Sprinkler assembly 300 further includes O-ring 304, protective-ring 305, and grip-ring 306. These components may sit within a recess or flange area of push-connect fitting 302, and further within an area generally designated as receiving area 307. In the embodiment shown, receiving area 307 is a portion of push connect fitting 307 having an enlarged circumference relative to the proximal end of push-connect fitting 302 and is shaped so as to house within its recess O-ring 304, protective-ring 305, grip-ring 306. As will be apparent to those skilled in the art, the specific shape of receiving area 307 and any recesses, grooves, or other guides within for holding such components may vary according to specific applications. The concepts and principals discussed with respect to FIGS. 2A-2D apply here to FIGS. 3A-3C, with the exception that there is no guide-ring. As a result, the end of the push connect fitting 302 is in closer proximity to grip-ring 306.

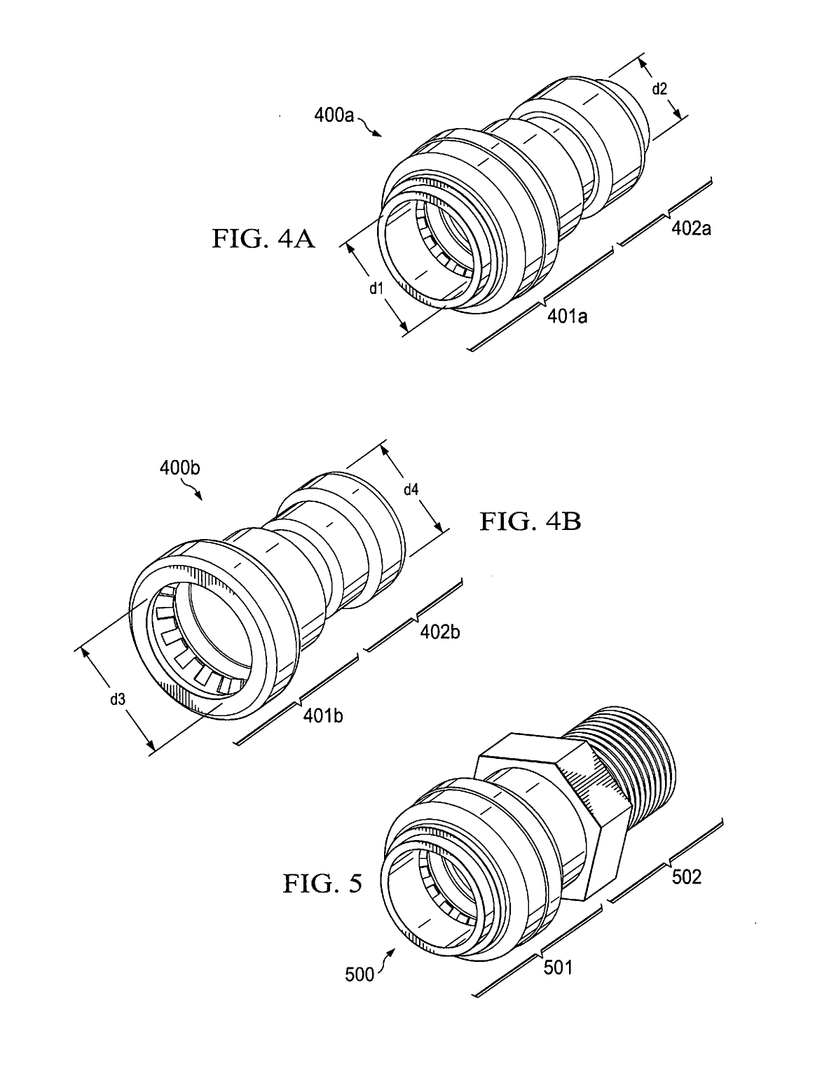

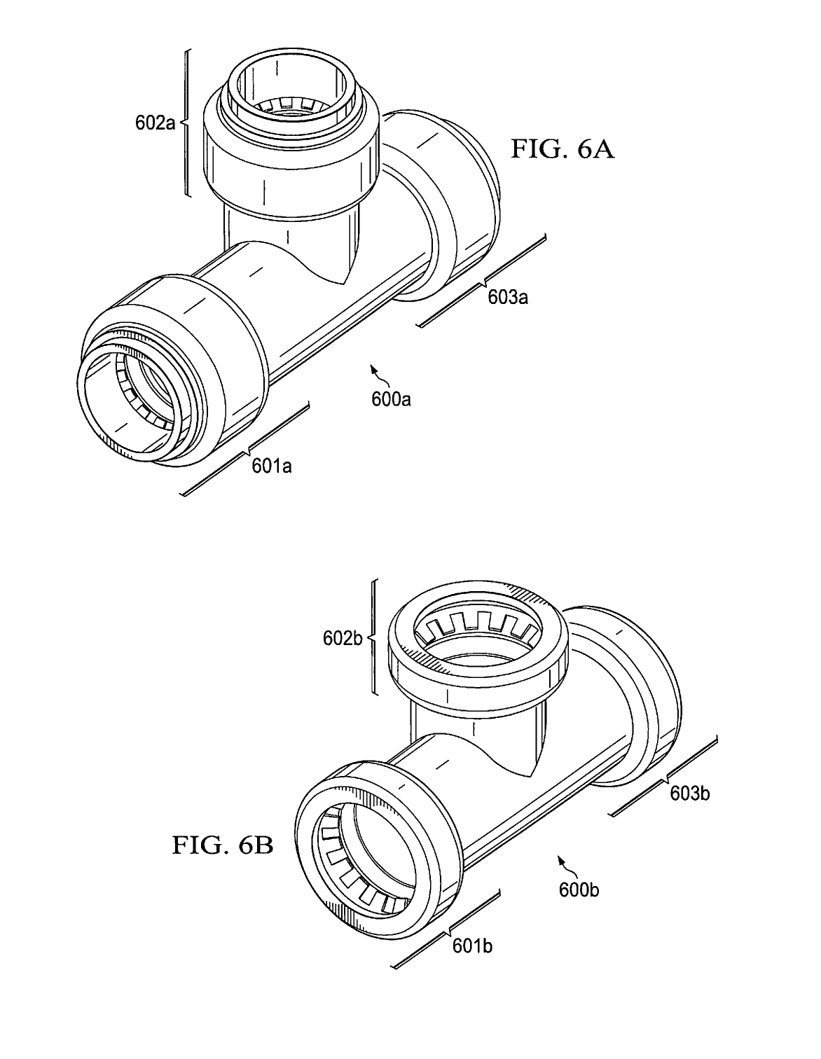

FIGS. 4A, 4B, 5, 6A, and 6B illustrate additional embodiments of a push-connect fitting according to embodiments described herein. In FIGS. 4A and 4B are shown dual push-connect fittings 400a and 400b. Hence, more than one push connect fitting may be employed in various embodiments. In FIGS. 4A and 4B, one push-connect receiving area (401a and 401b, respectively) has a diameter (d1 and d3, respectively) that is larger than the diameter (d2 and d4, respectively) of the opposing push-connect receiving area (402a and 402b, respectively). This allows two components of different diameters to be joined and still form a water tight seal. Either push connect opening, 401a or 402a of FIG. 4A, or 401b or 402b of FIG. 4B, could have one push connect fitting replaced with or connected to a sprinkler head. For example, the sprinkler head may be adapted to connect to one end of dual push-connect fittings 400a and 400b.

FIG. 5 shows another embodiment of a push-connect fitting 500 having a push-connect portion 501 and a threaded portion 502. Either push-connect portion 501 or threaded portion 502 could be used to connect a sprinkler head and a sprinkler system pipe. In one embodiment, for example, a sprinkler system pipe is connected to push-connect portion 501, and threaded portion 502 is connected to a sprinkler system pipe. In another embodiment, the reverse is applied, and a sprinkler head is adapted to mate with threaded portion 502 and push-connect portion 501 is used to connect the sprinkler head to a sprinkler system pipe.

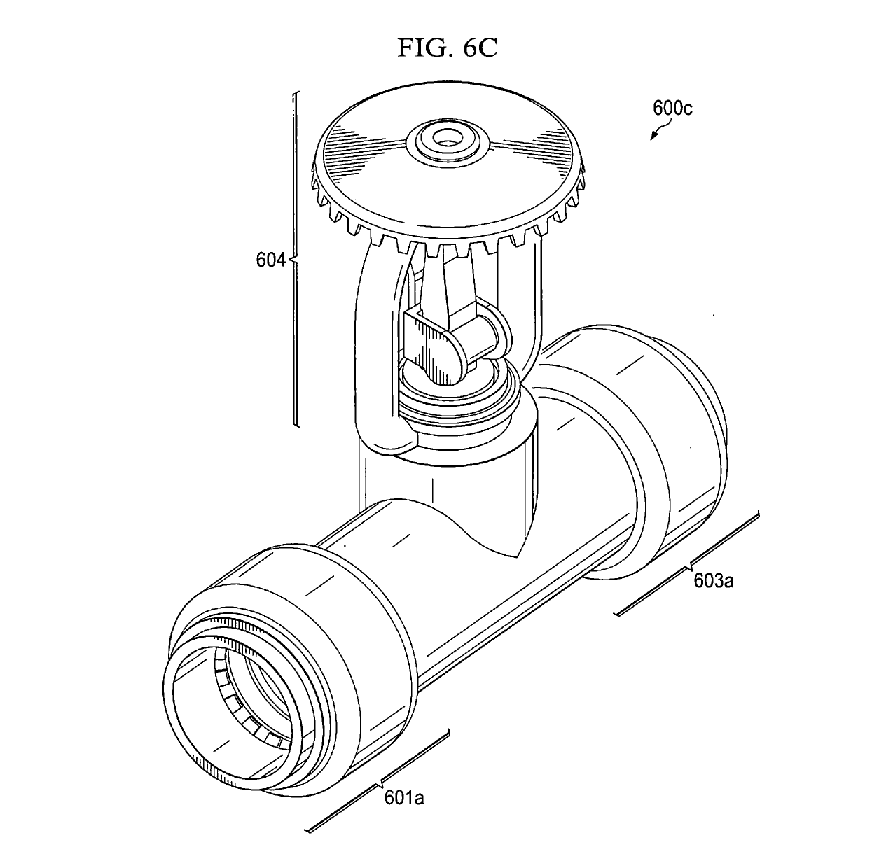

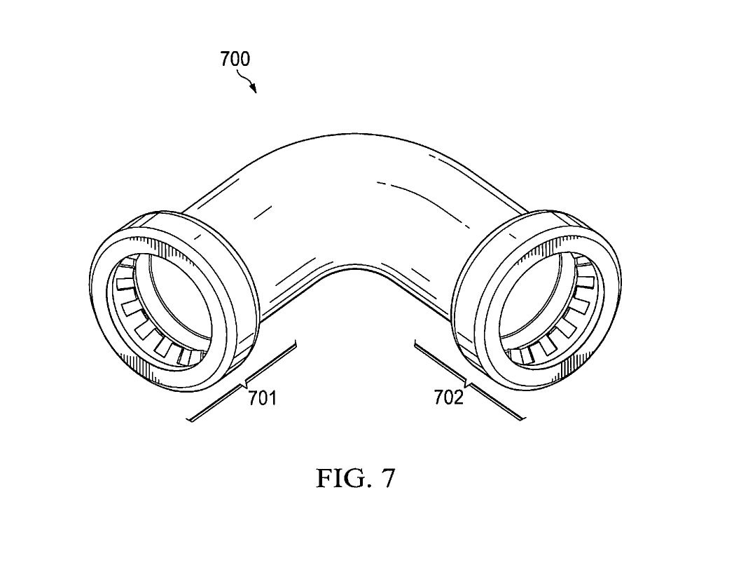

FIGS. 6A, 6B, and 6C depict additional embodiments of a push-connect fitting 600a, 600b, 600c having multiple receiving areas (orifices) (601a, 602a, 603a, and 601b, 602b, 603b, respectively) in the form of a T-joint for connection with one or more sprinkler system pipes and/or sprinkler heads. An embodiment 600C that includes a sprinkler head 604 is shown in FIG. 6C. Although shown at 90 degree angles (604 to 601a, and 604 to 603a), the receiving areas could be at other angles with respect to one another, for example 45 degrees or a Y-joint, in FIG. 6C and other embodiments.

FIG. 7 shows an embodiment of an elbow push-connect fitting 700, having two push-connect receiving areas 701 and 702. In the embodiment depicted in FIGS. 2A-2D, push-connect fitting 202 receives sprinkler head 201 and sprinkler system pipe 212 from directly opposing directions such that sprinkler head 201 and sprinkler system pipe 212 are parallel to one another at certain portions. In another embodiment, as shown in FIG. 7, the push-connect fitting may be curvilinear, such that when sprinkler system pipe, such as sprinkler system pipes 212 and 213, are inserted into receiving area 701 or 702, and a sprinkler head, such as sprinkler head 201 and 301, are joined with or replace the remaining receiving area, the sprinkler head will be at an angle to the sprinkler system pipe by virtue of the fitting. In this and other embodiments, a medial or proximal section of push-connect fitting 700 may include one or more stop-rings (not shown) or other mechanism to prevent a sprinkler system pipe from being inserted too far into push-connect fitting 700. Stop-ring may be an integrally formed ridge or bump traversing the inner circumference of such medial portion, small enough to not noticeably inhibit water flow, but larger enough to catch at least an edge of a sprinkler system pipe. The stop-ring may be continuous or discontinuous, or even just one knob on the inner surface of the medial portion. In one embodiment, sprinkler system pipe will abut the bottom of a sprinkler head.

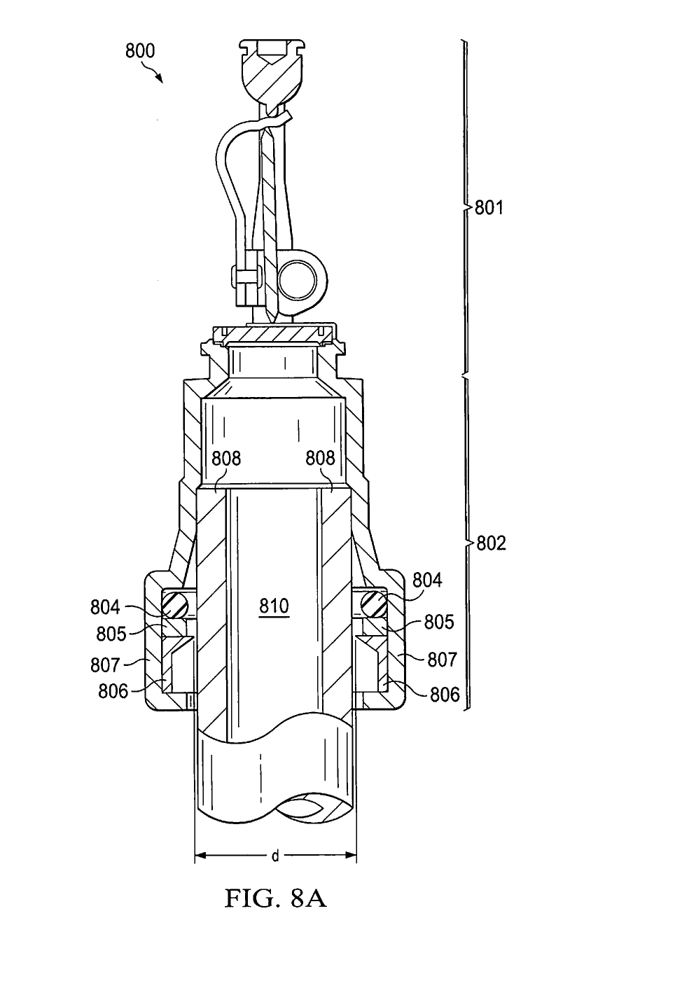

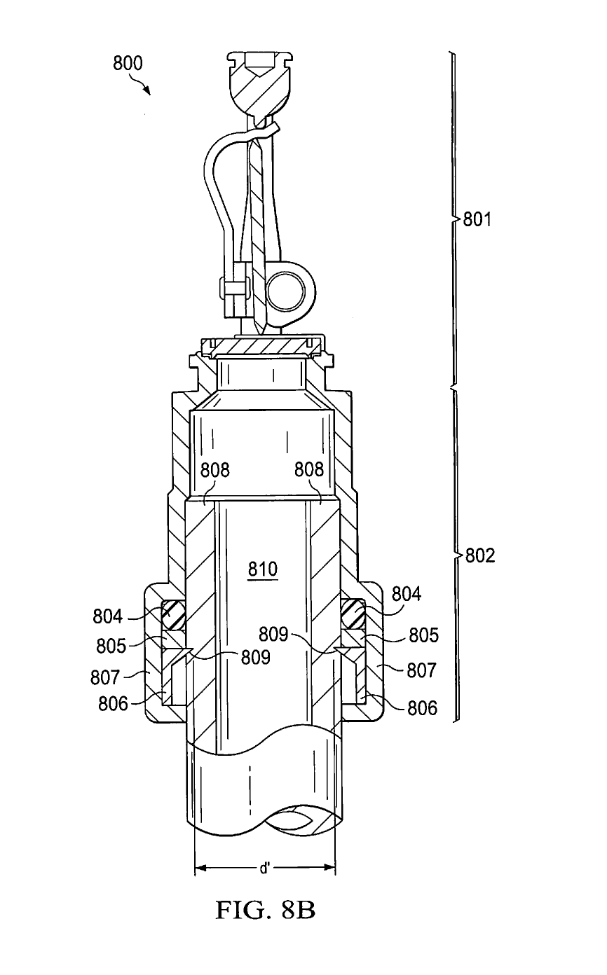

In another embodiment, a sprinkler system pipe is secured to a sprinkler head via a press-connect fitting. A press-connect sprinkler assembly 800 according to embodiments described herein is shown in FIG. 8A. In the embodiment shown, press-connect fitting 802 is connected to sprinkler head 801. Press-connect fitting 802 has at its distal end a receiving area 807 having enlarged circumference (with inner recess) as compared to the proximal end of press-connect fitting. As depicted in FIGS. 8A and 8B, receiving area 807 has a greater unpressed diameter d (FIG. 8A) than a pressed diameter d′ (FIG. 8B).

In various embodiments, a press-connect sprinkler assembly according to embodiments described herein may include multiple receiving areas/recesses for connecting one or more sprinkler heads to one or more sprinkler system pipes via press-connect fittings. In such embodiments, the press-connect sprinkler assembly, may form a T-joint, Y-joint, or joint of different angles (commonly 45 or 90 degrees) between a receiving area of a press-connect fitting a sprinkler head and/or another receiving area of another press-connect fitting.

One or more sprinkler heads and/or receiving areas may also be joined in an elbow or macaroni shaped configuration (see FIG. 7). Thus, for example, a press-connect fitting may be curvilinear such that when sprinkler system pipe, such as sprinkler system pipe 810, is inserting into receiving area 807, and a sprinkler head, such as sprinkler head 801, are joined, the sprinkler head will be at an angle to the sprinkler system pipe by virtue of the fitting. In this and other embodiments, a medial or proximal section of press-connect fitting 802 may include one or more stop-rings (not shown) or other mechanism to prevent a sprinkler system pipe from being inserted too far into press-connect fitting 802. A stop-ring may be an integrally formed ridge or bump traversing the inner circumference of such medial or proximal portion, small enough to not inhibit water flow, but larger enough to catch at least an edge of a sprinkler system pipe. The stop-ring may be continuous or discontinuous, or even just one knob on the inner surface of the medial or proximal portion. In one embodiment, sprinkler system pipe will abut the bottom of sprinkler head 801.

Within the recess of receiving area 807 are housed the components that enable the press-connected seal. These components include grab-ring 806, spacer-ring 805, and O-ring 804, each of which span the circumference of the receiving area 807 (inner surface) and sprinkler system pipe 810 (outer surface). As will be apparent to those skilled in the art, the specific shape of receiving area 807 may vary according to specific applications, for example, so as to effectively house a grab-ring, spacer-ring, and O-ring, and to further properly receive sprinkler system pipe 810 (i.e., sufficient diameter).

O-ring 804 is located furthest from the distal end (receiving end) of press-connect fitting 802 and within receiving area 807. In one embodiment, O-ring 804 forms a loop and includes an elliptical or disc-shaped cross-section when in a relaxed (uncompressed) state. Further, O-ring 804 may be an elastomer capable of being pressed or deformed, thereby filling space and coming into intimate contact with the inner surface of press-connect fitting 802 and sprinkler system pipe 810. O-ring 804 is also hydrophobic or otherwise impenetrable by the type of fluid handled in the system. O-ring 804 can beneficially have a variety of cross sections, e.g., elliptical, circular, x-shaped (or multi-lobal), square, etc., and could be further aligned or partially-seated in a groove or recess area of sprinkler system pipe 810 once inserted.

Spacer-ring 805 is located between O-ring 804 and grab-ring 806 within receiving area 807 of press-connect fitting 802. Spacer-ring 805 separates O-ring 804 and grab-ring 806. In one embodiment, spacer-ring 805 substantially fills the space between O-ring 804 and grab-ring 806. Spacer-ring 805 prevents O-ring 804 from getting damage or abrasions (e.g., from the edge of sprinkler system pipe 810 or from the sharp edges of grab-ring 806) during the installation operation (i.e., insertion of sprinkler system pipe 810 into press-connect fitting 802). To offer such protection, spacer-ring 805, in some embodiments, is a sufficiently hard material, e.g., plastic or the like. In some embodiments, spacer-ring 805 may have elastomeric properties. Spacer-ring 805 may also serve as support or stability for grab-ring 806. To perform such functions (space, protect, support), spacer-ring 805 may have a variety of cross-sectionals shapes, depending on the application and shape of press-connect fitting 802. Potential shapes include generally triangular (as shown in FIG. 2B), circular, x-shaped, square, rectangular, etc. Further, spacer-ring 805 may be partially-seated within a groove of receiving area 807 and could further be aligned and/or seated within a groove in sprinkler system pipe 810 once installed.

Installation begins by inserting sprinkler system pipe 810 within receiving area 807 opposite sprinkler head 801. Mechanical force is applied to receiving area 807 with a tool, actuating receiving area 807 components from an unpressed (initial unpressed diameter d) to pressed position (smaller pressed diameter d′). Existing tools may be used to complete the pressing operation. Under this mechanical force, the flanged space along receiving area 807 of press-connect sprinkler assembly 800 that, in some part, defines receiving area 807 has decreased, whereby a greater portion of the distal end is adjacent to sprinkler system pipe 810. Also, spacer-ring 805 substantially fills the space defined by O-ring 804, sprinkler system pipe 810, and grab-ring 806. In the actuated position, the internal sharp edged diameter of grab-ring 806 is now embedded in the outer surface of sprinkler system pipe 810, where portion 809 represents that portion of grab-ring 806 that is embedded within sprinkler system pipe 810 after the pressing operation.

Advantageously, the configuration (e.g., shape, diameter, hardness, malleability) of press-connect fitting 802 allows it to be pressed with standard tools known in the art. This pressure applied at receiving area 807 actuates grab-ring 806. The diameter reduction causes the sharp-edge of grab-ring 806 to penetrate surface 808 of sprinkler system pipe 810. Such pressure also introduces a calculated mechanical stress between O-ring 804, the contacted surfaces of press-connect fitting 802 (particularly, the inner surfaces of receiving area 807), and sprinkler system pipe 810 to form a seal. As long as the pressure of fluid being contained does not exceed this stress, leaking will not occur.

In certain embodiments, grab-ring 806 includes sharp-edged diameter and shape such that when pressed, the grab-ring's outside diameter is reduced, resulting in the sharp edge 809 embedding into sprinkler system pipe 810 surface 808. In one embodiment, the diameter reduction is facilitated by a gap in the circumference of grab-ring 806 which allows the grab-ring ends to slide together within the decreasing circumference of receiving area 807 to substantially or completely span the entire circumference of sprinkler system pipe 810 when in the final, pressed position.

In one embodiment, the geometry of grab-ring 806 is the primary strength of the joint formed between sprinklers system pipe 810 and sprinkler head 801. The twisting moment of the grab-ring, which occurs when the fitting is pressed is captured via the extended cross-section of the grab-ring being fully engaged with the inside surface of the fitting body, thus providing increased resistance to burst pressures, enhanced water hammer resistance, and minimal creep of the tube within the fitting under load. In addition, embodiments of the grab-ring design allow for efficient and effective pressing force to be applied directly through the grab-ring, thus gaining maximum penetration of the grab-ring into a sprinkler system pipe or other fluid management tubing. Effective grab-ring penetration provides the basis for the twisting moment when an axial force is applied. The twisting moment then translates to place the grab-ring outside diameter into intimate contact with the interior wall of the fitting.

Additional details with respect to push-connect fitting and grab-ring design are shown and described in U.S. patent application Ser. No. 12/818,942, filed Jun. 18, 2010 titled “PRESS-CONNECT FITTING WITH IMPROVED GRAB-RING FUNCTION,” the disclosure of which is hereby incorporated herein by reference.

Although various embodiments and their advantages have been described in detail, it should be understood that various changes, substitutions and alterations can be made herein without departing from the spirit and scope of those embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to embodiments described herein. Accordingly, the appended claims are intended to include within their scope such processes, machines, manufacture, compositions of matter, means, methods, or steps.

What is claimed is:

1. A press-connect sprinkler assembly comprising:
a sprinkler head;
a press-connect fitting having a recess in a distal end for receiving a pipe end;
a sealing ring in said recess to provide a fluid-tight seal after said fitting is pressed; and
a grab-ring in said recess having a continuous sharp edge to engage an outer surface of said pipe after said fitting is pressed.

2. The assembly of claim 1 further comprising a spacer-ring between said sealing ring and said grab-ring.

3. The assembly of claim 1 wherein said continuous sharp edge is at an angle between 5 degrees and 25 degrees from a plane orthogonal to the outer surface of said pipe.

4. The assembly of claim 1 wherein said continuous sharp edge is uniformly embedded in said pipe when said fitting is pressed.

5. A method of joining a sprinkler head and sprinkler pipe using a press-connect fitting, said method comprising:
inserting a pipe into a receiving end of said fitting, wherein said fitting is joined with said sprinkler head, and wherein said fitting comprises:
a sealing ring in a recess of said receiving end of said fitting; and
a grab-ring in said recess; and
pressing said recess, wherein said pressing causes an edge of said grab-ring to embed in an outer surface of said pipe, and reduces said outer-diameter of said grab-ring.

6. The method of claim 5 wherein said spacer-ring is between said sealing ring and said grab-ring.

7. The method of claim 5 wherein said edge is at an angle between 5 degrees and 25 degrees from a plane orthogonal to the outer surface of said pipe before said pressing of said fitting.

8. The method of claim 5 wherein said edge is uniformly embedded in said pipe as a result of said pressing.

9. A sprinkler system, said system comprising:
a plurality of pipes connected in a network;
a plurality of sprinkler heads each located at spaced intervals along said network;
a plurality of press-connect fittings, each of said fittings creating a fluid-tight joint between one of said plurality of pipes and one of said plurality of sprinkler heads by press activation, each of said plurality of fittings comprising:
a recess in a distal end of said fitting;
an O-ring in said recess, said O-ring forming a seal between said pipe and said fitting; and
a grab-ring in said recess, said grab-ring having a continuous sharp-edge embedded in said outer surface of said pipe and securing said pipe in said fitting.

10. The system of claim 9 wherein each of said plurality of fittings further comprise:
a spacer-ring in said recess between said O-ring and said grip-ring.
